(19) United States
(12) Patent Application Publication
(10) Pub. No.: US 2005/0085680 A1
(43) Pub. Date: Apr. 21, 2005

(54) Method for industrial decontamination

(76) Inventors: Joseph Auerbach, Brooklyn, NY (US); Junior T. Francis, Somerset, NJ (US); Ming-Huei Yue, Edison, NJ (US)

Correspondence Address: MERCK AND CO., INC, P O BOX 2000, RAHWAY, NJ, 07065-0907, US

(21) Appl. No.: 10/932,432

(22) Filed: Sep. 1, 2004

Related U.S. Application Data
(60) Provisional application No. 60/512,881, filed on Oct. 21, 2003.

(51) Int. Cl. A62D 3/00

(52) U.S. Cl. 588/315

(57) ABSTRACT

The present invention provides a method for low cost and non-toxic disposal/destruction of process waste containing; metals, metal salts and solvents (entrainment), which is easy and safe to handle and meets current effluent standards. According to one embodiment of the present invention the method is useful in the manufacture of amitriptyline hydrochloride and cyclobenzaprine hydrochloride.

### BACKGROUND OF THE INVENTION

In recent years, the increasing concern over the contamination of our environment by humans has resulted in a rapid growth of technology directed toward reducing such contamination, especially by industry. However, many contamination problems still remain unsolved, especially in the area of disposal/destruction of industrial wastes. Two such problem areas relate to disposal/destruction of organic solvent-containing waste sludges and metal- and metal salt-containing waste sludges.

The use of solvents is typical in industry, including the pharmaceutical industry, and many environmentally hazardous solvents are utilized in the manufacture and synthesis of bulk pharmaceuticals. Waste solvent (entrainment) contained in sludge, in the past, has been removed by water slurrying the sludge and then sewering, among other techniques. However, due to International, National, State and Local effluent guideline regulations (for example, Environmental Protection Agency; 40 C.F.R. Parts 9 and 63, “National Emission Standards for Hazardous Air Pollutants for Source Categories: Pharmaceutical Production” and 40 C.F.R. Parts 136 and 439, “Pharmaceutical Manufacturing Category Effluent Limitations Guidelines, Pretreatment Standards and New Source Performance Standards”), certain excess waste (solvents) may need to be transferred to drums/waste tanks and ultimately to offsite destruction.

The use of metal is typical in industry, including the pharmaceutical industry, and many hazardous metals are utilized in the manufacture and synthesis of bulk pharmaceuticals. For example, the Grignard reagent is a ubiquitous reactant in organic chemistry having numerous uses in industry. In utilizing the Grignard reagent, a final quench with a base (sodium hydroxide) allows separation of an organic product stream, by filtration, from solid magnesium salts that are formed. A problem with the use of these reagents and this quench procedure is the generation of a magnesium salt containing sludge after the reaction is over. Again, due to International, National, State and Local effluent emission guidelines, certain excess waste (metals and metal salts; for example, see reference to EPA guidelines above), may need to be transferred to drums/waste tanks and ultimately to offsite destruction.

In industry and in particular the pharmaceutical industry, process waste (metal salts, with un-reacted metal and solvents) is commonly generated in the form of sludge which is difficult to remove from process vessels. Typical means to extract the metal salt sludge include, but are not limited to, acid extraction wherein the metal salts are dissolved by hydrochloric acid (or another strong acid) and the resultant aqueous solution removed from the process vessel. However, hydrochloric acid, and other strong acids, are hazardous and corrosive to the process vessel and hydrogen chloride vapor (and other acid vapors) may be liberated.

Thus, there is a definite need for a method for disposal/destruction of metal, metal salt and/or solvent containing sludge that is cost effective, non-toxic and easy to perform and meets current effluent emission standards.

### SUMMARY OF THE INVENTION

The present invention provides a method for disposal/destruction of process waste containing; metal and/or metal salt and optionally in the presence of solvent, which is easy and safe to handle and meets current effluent standards.

It is an object of the present invention to provide a method for disposal/destruction of process waste comprising the steps of:
a) slurrying said process waste with a weak acid to form an aqueous solution; and
b) transferring said aqueous solution for disposal/destruction.

Another object of the present invention to provide a method for disposal/destruction of process waste from a Grignard reaction comprising the steps of:
a) slurrying said process waste with a weak acid to form an aqueous solution; and
b) transferring said aqueous solution for disposal/destruction.

Another object of the present invention is to provide a method useful in the manufacture of amitriptyline hydrochloride and cyclobenzaprine hydrochloride for disposal/destruction of process waste comprising the steps of:
a) slurrying said process waste with a weak acid to form an aqueous solution; and
b) transferring said aqueous solution for disposal/destruction.

A feature of the present invention is that said process waste is selected from metal and metal salt and optionally in the presence of solvent.

Another feature of the present invention is that said process waste is metal salt.

Another feature of the present invention is that said metal is magnesium.

Another feature of the present invention is that said metal salt is selected from magnesium hydroxide and magnesium hydroxy chloride.

Another feature of the present invention is that said solvent is selected from tetrahydrofuran (THF) and toluene.

Another feature of the present invention is that said weak acid is selected from citric acid, ethylenediaminetetraacetic acid (EDTA), acetic acid and the like.

Another feature of the present invention is that said weak acid is citric acid.

Another feature of the present invention is that said process waste is in the form of an aqueous solution, sludge or solid.

Another feature of the present invention is that said process waste is in the form of a sludge.

Another object of the present invention is to provide an industrial method for disposal/destruction of process waste comprising the steps of:
a) optionally aqueous slurrying said process waste to obtain a slurry in a process vessel;
b) charging said slurry with a weak acid to form an aqueous solution;
c) agitating said process vessel;
d) transferring said aqueous solution for external disposal/destruction; and
e) optionally rinsing said process vessel.

Another object of the present invention is to provide an industrial method for disposal/destruction of process waste from a Grignard reaction comprising the steps of:
a) optionally aqueous slurrying said process waste to obtain a slurry in a process vessel;
b) charging said slurry with a weak acid to form an aqueous solution;
c) agitating said process vessel;
d) transferring said aqueous solution for external disposal/destruction; and
e) optionally rinsing said process vessel.

Another object of the present invention is an industrial method useful in the manufacture of amitriptyline hydrochloride and cyclobenzaprine hydrochloride for disposal/destruction of process waste comprising the steps of:
a) aqueous slurrying said process waste to obtain a slurry in a process vessel;
b) charging said slurry with a weak acid to form an aqueous solution;
c) agitating said process vessel;
d) transferring said aqueous solution for external disposal/destruction; and
e) rinsing said process vessel.

A feature of the present invention is that said process waste is selected from metal and metal salt and optionally in the presence of solvent.

Another feature of the present invention is that said process waste is metal salt.

Another feature of the above described present invention is that said metal is magnesium.

Another feature of the above described present invention is that said metal salt is selected from magnesium hydroxide and magnesium hydroxy chloride.

Another feature of the above described present invention is that said solvent is selected from tetrahydrofuran (THF) and toluene.

Another feature of the above described present invention is that said weak acid is selected from citric acid, ethylenediaminetetraacetic acid (EDTA), acetic acid and the like.

Another feature of the above described present invention is that said weak acid is citric acid.

Another feature of the present invention is that said process waste is in the form of an aqueous solution, sludge or solid.

Another feature of the present invention is that said process waste is in the form of a sludge.

Another feature of the present invention is that said agitating step occurs for about 0-4 hours.

Another object of the present invention is a method for quenching a Grignard reaction comprising citric acid addition during the quench procedure to effectuate the quench and complex with metal wherein said metal is dissolved and treated as an effluent guideline stream.

A feature of the above described present invention is that said metal is magnesium.

### DETAILED DESCRIPTION OF THE INVENTION

The present invention provides a method for low cost and non-toxic disposal/destruction of process waste containing; metal and/or metal salt and optionally in the presence of solvent, which is easy and safe to handle and meets current effluent standards. In particular the disposal/destruction is accomplished through the use of a weak acid. An example of a weak acid includes, but is not limited to, citric acid.

The present invention relates to an improved method of removing metal salt generated from a reaction process. The present invention applies to a reaction process that can be performed on a laboratory bench or in a scaled-up (small batch and/or large batch) industrial setting. Examples of this improved method of removing metal salt from a reaction process are demonstrated in Examples 1 and 2 contained herein; wherein metal salt is generated in a process vessel (in the form of a sludge) after a Grignard reaction step. As referenced herein, product (amicarbinol and cyclocarbinol), formed after the Grignard reaction, is filtered away leaving a metal (Mg) salt sludge. This sludge is then treated with a weak acid and is subsequently transferred for disposal/destruction. Optionally included in the removal process are other process wastes including un-reacted metal and solvent. These “other process wastes” may be in any quantity formed after the reaction has completed, including higher concentrations of metal and solvent when the reaction has failed or only partially reacted (in which case two phases, organic and aqueous, can be separated), or no metal if the reaction has completed fully.

The present invention can additionally be used to dispose of partially initiated Grignard reagents. Such reagents may contain non-useful amounts of Grignard reagent (which are a hazard) and substantial unreacted Mg metal (which is a chemical hazard in this state). By addition of sufficient aqueous weak acid (including citric acid) both the Grignard reagent and unreacted Mg metal can be solubilized to form an aqeous weak acid (citric acid) solution for disposal. Any separable organic solvent can additionally be disposed.

The present invention is applicable for removal of process waste (metal and/or metal salt and optionally in the presence of solvent) that is un-reacted or formed after a reaction process. In particular, the present invention is applicable for removal of metal salt. Typically “process waste” may be in the form of an aqueous solution, sludge, or solid (cake). The definition of an aqueous solution, sludge, or solid is that definition that is typically used in industry and is readily determined by one of ordinary skill in the art.

The present invention is applicable to remove metal for disposal/destruction. “Metal” means any metal typically used in industry, including the pharmaceutical industry. Examples of metal that are applicable according to the instant method include, but are not limited to, K, Na, Ca, Zn and Mg, and any isotopes or combinations thereof. In another embodiment of the instant invention, the metal is Mg.

The present invention is applicable to remove metal salt for disposal/destruction. “Metal salt” means any metal salt typically used in industry, including the pharmaceutical industry. Examples of metal salt that are applicable according to the instant method include, but are not limited to, hydroxides, carbonates, oxides, halides, acetates and hydroxy halides and any isotopes or combinations thereof. In another embodiment of the instant invention, the metal salt is hydroxides and hydroxy chlorides.

The present invention is applicable to remove solvent for disposal/destruction. “Solvent” means any solvent typically used in industry, including the pharmaceutical industry. Examples of solvent that are applicable according to the instant method include, but are not limited to, aliphatics, aromatics and ethers and combinations thereof. In another embodiment of the instant invention, the solvent is tetrahydrofuran (THF) and toluene. “Solvent”, in the instant application, may be referred to as “entrainment”.

The present invention provides a low cost and non-toxic disposal/destruction method that comprises slurrying process waste (including process waste generated from a Grignard reaction) in the form of an aqueous solution, sludge and/or solid with a weak acid to form an aqueous solution and then transferring the aqueous solution for waste disposal/destruction. The present invention also provides an industrial method useful in the manufacture of amitriptyline hydrochloride and cyclobenzaprine hydrochloride for low cost and non-toxic disposal/destruction of process waste (typically in the form of a sludge) with a weak acid to form an aqueous solution and then transferring the aqueous solution for waste disposal/destruction.

“Slurrying” comprises the addition of water or the addition of a weak acid or the addition of a solution of a weak acid and water to the process waste (metal, metal salt, and/or solvent). The process waste may be in the form of an aqueous solution, sludge and/or solid. During the slurrying step, the process waste may be mixed or agitated to allow the process waste to form an aqueous solution that can easily be removed and transferred for disposal/destruction.

Generally, acids typically used in the slurrying process are volatile and caustic to a reaction vessel. The acids used according to the instant invention are non-toxic weak acids and include, but are not limited to, citric acid, ethylenediaminetetraacetic acid (EDTA) and acetic acid. In another embodiment of the instant invention is the use of citric acid as the weak acid. Citric acid is an inexpensive, odorless, non-toxic solid tricarboxylic acid of moderate acidity which is safe and easy to handle. The weak acid used in the method of the instant invention reacts with metal salt, adjusts the pH of the solution and reacts with any residual metal to form hydrogen and a soluble salt.

“Transferring” comprises the removal of the aqueous solution generated after slurrying and includes metal salt, metal (as the salt form upon reaction with the weak acid) and any residual solvent (entrainment) from the reaction vessel and subsequent storing and/or offsite destruction.

In another embodiment, the present invention also provides a low cost and non-toxic disposal/destruction industrial method and an industrial method useful to remove process waste in the manufacture of amitriptyline hydrochloride and cyclobenzaprine hydrochloride that comprises the steps of:
a) optionally aqueous slurrying said process waste to obtain a slurry in a process vessel;
b) charging said slurry with a weak acid to form an aqueous solution;
c) agitating said process vessel;
d) transferring said aqueous solution for external disposal/destruction; and
e) optionally rinsing said process vessel.

“Aqueous slurrying” comprises the addition of water to the process waste (metal, metal salt, and/or solvent). The process waste may be in the form of an aqueous solution, sludge and/or solid. During aqueous slurrying, the process waste may be mixed or agitated to allow the process waste to form an aqueous solution. The amount of water needed would be readily determined by one of ordinary skill in the art and generally would be that amount of water needed to make a slurry from sludge and solid contaminants. This step may not be needed if the process waste is already in an aqueous solution or a dilute sludge.

“Charging” comprises the addition of a weak acid to the slurry. The weak acid is any non-toxic acid as defined herein. The weak acid may be diluted with water as needed to dissolve the process waste and would be readily determined by one of ordinary skill in the art. The acid can range from a 0% to a 100% acid solution, thus a pure acid “solid” may be added to the slurry. The weak acid can be a 50% acid solution. Different non-toxic weak acids may be mixed as needed and/or diluted with water and would be readily determined by one of ordinary skill in the art. The amount of weak acid needed would be readily determined by one of ordinary skill in the art and would depend on the process waste form (aqueous solution, sludge and/or solid) and the amount of process waste in the process vessel that would need to be dissolved.

“Agitating” comprises the mixing or shaking of the process vessel to further mix the weak acid and process waste to achieve an aqueous solution. Depending on the process waste form (i.e. aqueous solution or a dilute sludge) this step may not be needed and would be readily determined by one of ordinary skill in the art. The agitating step may take hours, including from 0 to 4 hours, also including 2 hours. The length of time needed to agitate would be readily determined by one of ordinary skill in the art.

The “transferring” step allows for complete removal of the aqueous solution and ultimately the removal of metal, metal salt and/or solvent contained within the aqueous solution. The transferring step could be performed by pouring, decanting and any vacuum means capable of removing the aqueous solution.

An optional step includes the “rinsing” step. Rinsing may need to be performed if the reaction vessel is to be re-used. The rinsing step may be accomplished by any means well known in the art for removing trace waste, most commonly with a water wash. The rinsing step may also be accomplished by using a spray-ball with sufficient amount of water to remove trace waste.

### EXAMPLE 1

### Destruction of Magnesium Waste Salt in the Amicarbinol Process

The Amicarbinol Process

Amicarbinol is the intermediate formed in the process for synthesizing amitryptiline. The synthesis of amicarbinol is well known and has been disclosed in the following patents: GB 858,186; U.S. Pat. No. 3,384,663; U.S. Pat. No. 3,428,735 and U.S. Pat. No. 3,780,106. Upon filtration of the amicarbinol product, residual metal, metal salt, and solvent can be disposed/destroyed via the following method.

Citric Acid Treatment of Process Vessel Waste Salt

The waste magnesium salts generated in a process vessel after the Grignard reaction step in the amicarbinol process are wet with THF and toluene. These salts are historically disposed by dissolving with hot water to the chemical sewer. With the implementation of Effluent Guideline regulations, this stream can no longer be sewered. The stream contains 50 kg of THF and 64 kg of toluene while the sewerage limit is 26.3 kg and 75.8 kg of THF and toluene per day respectively.

A procedure using 50% (w/w) aqueous citric acid solution to dissolve the magnesium salt waste stream containing THF and toluene was successfully developed in the laboratory and easily scaled-up to 189.25 L/75 kg of salt solids (dry basis). This procedure requires that 50 gallons of 50% (w/w) aqueous citric acid be used on the salts in the process vessel after the amicarbinol batch (in THF and toluene) is filtered away. The process vessel is then rinsed to a maximum level of citric acid (10 ppm) in preparation for the subsequent amicarbinol batch.

Initial Small Scale Development

About 6.15 g of wet salt (40% LOD) was found to dissolve in 4.03 g of citric acid. The estimated citric acid required to neutralize the waste salt was approximately 0.01 mole/g of waste salt.

Solid precipitate was seen within a week at room temperature even if using about 10% excess of citric acid. To prevent solid precipitation within that time period, 50% excess of citric acid was proposed to be the target charge. This charge is equivalent to one 50-gallon drum of 50% aqueous citric acid per batch. In a run, no precipitation occurred up to 21 days. Similar storage time was noted on experiment with a slight (approximately 10%) overcharge and undercharge of citric acid versus the target of 50% excess aqueous citric acid. After aging for 2 months, however, solid precipitate was still observed.

Initial Large Scale Laboratory Experiments

Assuming the wet cake weight per batch is 125 kg (approximately 75 kg dry basis), the estimated quantity of acid used to quench the Grignard reaction is 1.19 kg/mole.

Three larger scale laboratory experiments (5×, 10× and 27×) were conducted to confirm initial development results. These experiments showed that, at the factory scale, there will only be a trace amount of solids remaining (0.0 kg to 0.8 kg) in approximately 350 gallons of citric acid waste. This dilute solid concentration will not present a discharge problem from the process vessel. The pH of this waste solution was confirmed to be approximately 3.5. The solution was stored at −5° C. for one week with no freezing observed.

Safety and Corrosion Testing

No exothermic activity was observed on wet salt, wet salt after water addition, and wet salt after citric acid neutralization.

Flash point testing was conducted on a waste citric acid sample, after waste salt dissolution. The flash point was greater that 150° F.

The process vessel and initially proposed waste storage tanks are made of 316SS and 316L SS respectively. A corrosion laboratory study was conducted at 60° C. to determine compatibility between 316L SS and wet salt after citric acid neutralization. The 316L SS is suitable for short-term use (up to 30 days) at temperatures up to 60° C. with the waste citric acid solution generated during the magnesium waste salt dissolution procedure. Due to potential localized corrosion (pitting and crevice attack) after prolonged exposure (61 days), anti-pitting measures such as good agitation, oxygen control, and cleaning after use are recommended.

Final Magnesium Waste Dissolution Procedure

The following procedure is to be executed after batch (amicarbinol) is filtered and the follow-wash of the residual waste Mg salt cake (approximately 75 kg dry basis) in the process vessel with THF/Toluene is completed as per standard batch procedures.
a) Charge 200 gallons of DI water to slurry the waste Mg salt cake;
b) Charge 520 kg (2 drums) of 50% (w/w) aqueous citric acid to the slurried cake maintaining temperature between 2040° C.
c) Mix for 2 hours to assure complete dissolution. Confirm dissolution. Check pH; expect 3 to 4.
d) Drum off the waste citric acid solution for external destruction.
e) Rinse the process vessel through a spray-ball with 50 gallons of DI water and drum off for external destruction.
f) Rinse the process vessel to sewer with DI water to achieve a maximum of 200 ppm of residual citric acid as determined by cleaning validation.
g) Optionally swab the process vessel to a level of maximum 1 mg citric acid/swab.

### EXAMPLE 2

### Destruction of Magnesium Waste Salt in the Cyclocarbinol Process

The Cyclocarbinol Process

Cyclocarbinol is the intermediate formed in the process for synthesizing cyclobenzaprine. The synthesis of cyclocarbinol is well known and has been disclosed in the following patents: GB 858,186; U.S. Pat. No. 3,454,643 and U.S. Pat. No. 3,780,106. Upon filtration of the cyclocarbinol product, residual metal, metal salt, and solvent can be disposed/destroyed via the following method.

Citric Acid Treatment of Process Vessel Waste Salt

The waste magnesium salts generated in a process vessel after the Grignard reaction step in the cyclocarbinol process are wet with THF and toluene. These salts are historically disposed by dissolving with hot water to the chemical sewer. With the implementation of Effluent Guideline regulations, this stream can no longer be sewered. The sewerage limit is 26.3 kg and 75.8 kg of THF and toluene per day respectively.

A procedure using 50% (w/w) aqueous citric acid solution to dissolve the magnesium salt waste stream containing THF and toluene was successfully developed in the laboratory and easily scaled-up to 41 kg of salt solids (dry basis). This procedure requires a minimum of two full drums (520 kgs) of 50% (w/w) aqueous citric acid be used on the salts in the process vessel after the cyclocarbinol batch (in THF and toluene) is filtered away. The process vessel is then rinsed to a maximum level of citric acid (200 ppm) in preparation for the subsequent cyclocarbinol batch.

Final Magnesium Waste Dissolution Procedure

The following procedure is to be executed after batch (cyclocarbinol) is filtered and the follow-wash of the residual waste Mg salt cake in the process vessel with THF/Toluene is completed as per standard batch procedures.
a) Charge 200 gallons of DI water to slurry the waste Mg salt cake.
b) Agitate (or continue slurry) for 20 minutes.
c) Charge 520 kg (2 full drums) of 50% (w/w) aqueous citric acid to the slurried cake, with a 5 gallon DI water follow flush.
d) Agitate the solution for 2 hours.
e) Drum off the waste citric acid solution for external destruction.
f) Rinse the process vessel through a spray-ball with 50 gallons of DI water and drum off for external destruction.
g) Rinse the process vessel to sewer with DI water to achieve a maximum of 200 ppm of residual citric acid as determined by cleaning validation.
h) Optionally swab the process vessel to a level of maximum 1 mg citric acid/swab.

1. A method for disposal/destruction of process waste comprising the steps of:
a) slurrying said process waste with a weak acid to form an aqueous solution; and
b) transferring said aqueous solution for waste disposal/destruction.

2. The method of claim 1 wherein said process waste is selected from metal and metal salt and optionally in the presence of solvent.

3. The method of claim 2 wherein said process waste is metal salt.

4. The method of claim 1 wherein said weak acid is citric acid.

5. (canceled)

6. (canceled)

7. A method useful in the manufacture of amitriptyline hydrochloride and cyclobenzaprine hydrochloride for disposal/destruction of process waste comprising the steps of:
a) slurrying said process waste with a weak acid to form an aqueous solution; and
b) transferring said aqueous solution for waste disposal/destruction.

8. The method of claim 7 wherein said process waste is selected from metal and metal salt and optionally in the presence of solvent.

9. The method of claim 8 wherein said process waste is metal salt.

10. The method of claim 7 wherein said weak acid is citric acid.

11. (canceled)

12. (canceled)

13. (canceled)

14. (canceled)

15. (canceled)

16. (canceled)

17. An industrial method useful in the manufacture of amitriptyline hydrochloride and cyclobenzaprine hydrochloride for disposal/destruction of process waste comprising the steps of:
a) aqueous slurrying said process waste to obtain a slurry in a process vessel;
b) charging said slurry with a weak acid to form an aqueous solution;
c) agitating said process vessel;
d) transferring said aqueous solution for external disposal; and
e) rinsing said process vessel.

18. The method of claim 17 wherein said process waste is selected from metal and metal salt and optionally in the presence of solvent.

19. The method of claim 18 wherein said process waste is metal salt.

20. The method of claim 17 wherein said weak acid is citric acid.
